(19) United States
(12) Patent Application Publication
(10) Pub. No.: US 2024/0043607 A1
(43) Pub. Date: Feb. 8, 2024

(54) CURABLE RESIN COMPOSITION

(71) Applicant: THREEBOND CO., LTD., Hachioji-shi, Tokyo (JP)

(72) Inventor: Jyunya IWASAWA, Hachioji-shi, Tokyo (JP)

(21) Appl. No.: 18/546,707

(22) PCT Filed: Feb. 4, 2022
(86) PCT No.: PCT/JP2022/004398

§ 371 Date: Aug. 16, 2023

(30) Foreign Application Priority Data
Mar. 2, 2021 (JP) 2021-032251

(51) Int. Cl. C08G 59/24; C08K 3/36; C08K 9/06; C08G 59/50; C08G 59/40; C08G 59/22

(52) U.S. Cl. CPC C08G 59/245; C08K 3/36; C08K 9/06; C08G 59/502; C08G 59/4064; C08G 59/223; C08K 2201/005; C08K 2201/006; C08G 2170/00; C08G 2190/00

(57) ABSTRACT

The present invention relates to an epoxy resin composition having excellent low-temperature curability and excellent permeability into a clearance of a narrow portion. An epoxy resin composition containing components (A) to (C) below:
the component (A): a compound having two or more epoxy groups;
the component (B): silica treated with phenylaminosilane; and
the component (C): a compound curing the component (A).

### TECHNICAL FIELD

The present invention relates to a curable resin composition having low-temperature curability and favorable permeability into a clearance in a narrow portion.

Conventionally, compositions using epoxy resins have been widely used in various fields because of their excellent heat resistance and chemical resistance. In recent years, from the viewpoint of miniaturization and weight reduction of various components, an adhesive or sealing agent having low-temperature curability has been widely required in order to suppress the influence of heat on members. In particular, since a small electronic component is greatly affected by heat, low-temperature curability at 120° C. or lower is important. Moreover, in recent years, the structure of a small component has become complicated, and there is a need to allow a resin to penetrate into a clearance of a narrow portion of 500 μm or less and to bond and seal the narrow portion. (JP 2019-199511 A) When the permeability of the adhesive or sealing agent is poor with respect to the clearance of such a small component, the adhesive area is reduced, and adhesive strength or durability is reduced, so that the adhesive or sealing agent cannot have a sufficient function as an original adhesive or sealing agent.

### SUMMARY OF INVENTION

In order to improve permeability, the simplest method is a method of adding a solvent to reduce a viscosity and improve fluidity. Since the solvent is volatile, there is an advantage that the performance of a resin composition after volatilization is not affected. However, there is a problem in that the solvent cannot be volatilized in a narrow clearance and remains in a cured product even after curing, which causes a decrease in performance as an adhesive or a sealing agent.

The present inventors have conducted intensive studies in order to solve the above problems, and as a result, have invented a curable resin composition which has low-temperature curability and can improve permeability without using a solvent.

The gist of the present invention will be described below.
[1] A curable resin composition containing components (A) to (C) below and having a viscosity at 25° C. of 10 Pa·s or less:
   the component (A): a compound having two or more epoxy groups;
the component (B): silica treated with phenylaminosilane; and
   the component (C): a compound curing the component (A).
[2] The curable resin composition according to [1], wherein the component (A) is a compound having a bisphenol skeleton.
[3] The curable resin composition according to [1] or [2], wherein the component (C) is an amine adduct latent curing agent.
[4] The curable resin composition according to any one of [1] to [3], wherein a softening point or melting point of the component (C) is 150° C. or lower.
[5] The curable resin composition according to any one of [1] to [4], further containing a reactive diluent as a component (D).
[6] The curable resin composition according to [5], wherein the reactive diluent is an epoxy compound having an aromatic ring.
[7] The curable resin composition according to any one of [1] to [6], further containing a thiol curing agent as a component (E).
[8] The curable resin composition according to [7], wherein the thiol curing agent is a thiol curing agent containing no ester bond.
[9] The curable resin composition according to any one of [1] to [8], being used for an adherend containing nickel.
[10] A cured product of the epoxy resin composition according to any one of [1] to [9].

### DESCRIPTION OF EMBODIMENTS

Details of the invention will be described below. In the present specification, “X to Y” is used to mean that the first and last numerical values (X and Y) are included as a lower limit value and an upper limit value, and means “X or more and Y or less”.

An aspect of the present invention is a curable resin composition containing components (A) to (C) below and having a viscosity at 25° C. of 10 Pa·s or less:
the component (A): a compound having two or more epoxy groups;
the component (B): silica treated with phenylaminosilane; and
the component (C): a compound curing the component (A).

Since the curable resin composition of the present invention has low-temperature curability and is excellent in permeability into a narrow clearance of a small electronic component or the like, the curable resin composition is very useful.

The component (A) used in the present invention is not particularly limited as long as it is a compound having two or more epoxy groups in one molecule. The component (A) is not particularly limited, and examples thereof include, but are not limited to, a bisphenol A type epoxy resin, a bisphenol F type epoxy resin, a bisphenol S type epoxy resin, a bisphenol AD type epoxy resin, a naphthalene type epoxy resin, a biphenyl type epoxy resin, a phenol novolac type epoxy resin, a brominated bisphenol A type epoxy resin, a hydrogenated bisphenol A type epoxy resin, a glycidylamine type epoxy resin, a dicyclopentadiene type epoxy resin, an orthocresol novolac type epoxy resin, an alicyclic epoxy resin, and the like. These may be used singly or in combination of two or more kinds thereof. Among the components (A), from the viewpoint of excellent permeability, a bisphenol A type epoxy resin and a bisphenol F type epoxy resin are preferable, and a mixture of a bisphenol A type epoxy resin and a bisphenol F type epoxy resin is more preferable.

The epoxy equivalent of the component (A) is preferably 50 to 400 g/eq and more preferably 100 to 300 g/eq, from the viewpoint of low-temperature curability. The viscosity of the component (A) at 25° C. is preferably 0.5 or more and less than 100 Pa·s, further preferably 0.7 to 50 Pa·s, and most preferably 1 or more and less than 10 Pa·s, from the viewpoint of permeability.

Examples of commercially available products of the component (A) include, but are not limited to, jER828, 1001, 806, 807, 152, 604, 630, 871, YX8000, YX8034, and YX4000 (manufactured by Mitsubishi Chemical Corporation), Epiclon 830, EXA-830LVP, EXA-850CRP, EXA-835LV, HP4032D, HP4700, and HP820 (manufactured by DIC Corporation), EP-4100, EP-4100G, EP-4100E, EP-4100TX, EP-4300E, EP-4000, EP-4000G, EP-4000E, EP-4000TX, EP-4005, EP-4400, EP-4520S, EP-4530, EP-4901, EP-4901EP-4080, EP-4085, EP-4088, EP-5100-75X, EP-7001, EP-4080E, EPU-6, EPU-7N, EPU-11F, EPU-15F, EPU-1395, EPU-73B, EPU-17, EPU-17, EPU-17T-6, EPU-80, EPR-1415-1, EPR-2000, EPR-2007, EPR-1630, EP-49-10N, EP-49-10P2, EPR4023, and EPR2007 (manufactured by ADEKA Corporation), Denacol EX-612, EX-614, EX-622, EX-314, EX-412, EX-521, and EX-411 (manufactured by Nagase ChemteX Corporation), TEPIC, TEPIC-S, and TEPIC-VL (manufactured by Nissan Chemical Corporation), SY-35M, SR-NPG, and SR-TMP (manufactured by Sakamoto Yakuhin Kogyo Co., Ltd.), and the like. These may be used singly or as a mixture of two or more kinds thereof.

The component (B) used in the present invention is silica surface-treated with phenylaminosilane. The component (B) can be obtained by reacting a hydroxyl group present on the surface of silica particles with phenylaminosilane. The phenylaminosilane described in the present invention refers to an alkoxysilane having a phenylamino group. Examples thereof include N-phenyl-γ-aminopropyltrimethoxysilane, N-phenyl-γ-aminopropyltriethoxysilane, 3-phenylaminopropyltrimethoxysilane, 3-phenylaminopropyltriethoxysilane, and the like, and among these, from the viewpoint of permeability, N-phenyl-γ-aminopropyltrimethoxysilane and N-phenyl-γ-aminopropyltriethoxysilane are preferable, and N-phenyl-γ-aminopropyltrimethoxysilane is more preferable. By adding the component (B), permeability into a narrow portion can be improved. The shape of the component (B) is preferably spherical from the viewpoint of permeability. From the viewpoint that the influence on permeability can be reduced, the 50% average particle size is preferably 0.1 to 5 μm, more preferably 0.1 to 3 μm, and most preferably 0.1 to 1 μm. Examples of a method for confirming the 50% average particle size include image analysis using a particle size/shape distribution measuring instrument of a laser diffraction scattering type or a micro-sorting control type, an optical microscope, an electron microscope, and the like. In the present invention, a laser diffraction scattering type is used.

The component (B) is contained in an amount of preferably 0.1 to 200 parts by mass, more preferably 1 to 120 parts by mass, and most preferably 10 to 80 parts by mass, with respect to 100 parts by mass of the component (A). When the content is 0.1 or more, permeability can be improved, and when the content is 200 parts by mass or less, there is no concern that permeability is lowered.

The component (C) used in the present invention is a compound curing (A) (provided that the component (E) is not included). From the viewpoint of low-temperature curability and storage stability, the component (C) is preferably a solid at 25° C. Examples of the component (C) include a thermal curing agent and a photocuring agent. Examples of the thermal curing agent include a latent curing agent and a thermal cationic polymerization initiator, and examples of the photocuring agent include a photocationic polymerization initiator, a photobase generator, and the like. Among them, from the viewpoint that curing can be performed when a member is not necessarily a permeable member such as glass, thermal curing agents such as a latent curing agent and a thermal cationic polymerization initiator are preferable, and a latent curing agent capable of curing even at a lower temperature is more preferable.

Examples of the latent curing agent include aliphatic and aromatic amine compounds, imidazole and derivatives thereof, an acid anhydride compound, a polyamide compound, a hydrazide compound, novolac resins such as phenol novolac and cresol novolac, an amine adduct compound, a urea adduct compound, an imidazole adduct compound, dicyandiamide and derivatives thereof, and the like. These may be used singly or in combination of two or more kinds thereof. Among them, from the viewpoint of low-temperature curability and storage stability, imidazole and derivatives thereof, and an amine adduct latent curing agent obtained by pulverizing an amine adduct compound in which a tertiary amine is added to an epoxy resin to stop the reaction in the middle are preferably used, an amine adduct latent curing agent is more preferable, and a modified aliphatic polyamine adduct and a modified alicyclic polyamine adduct are most preferable. In the case of using an amine adduct latent curing agent as the component (C), from the viewpoint of low-temperature curability, the amine value is preferably 80 to 200 and more preferably 90 to 150.

Examples of commercially available products of the latent curing agent include AJICURE PN-23, PN-23J, PN-31, PN-31J, PN-40J, PN-H, PN-R, MY-24, and MY-R (manufactured by Ajinomoto Fine-Techno Co., Inc.), Fujicure FXE-1000, Fujicure FXR-1030, and Fujicure FXR-1081 (manufactured by T&K TOKA CO., LTD.), CUREZOL SIZ, 2MZ-H, C11Z, C17Z, 2PZ, 2PZ-PW, and 2P4MZ (manufactured by SHIKOKU CHEMICALS CORPORATION), and the like.

Examples of the thermal cationic polymerization initiator include a thermal cationic polymerization initiator containing a salt composed of a hexafluoroantimonate anion and a cation, a thermal cationic polymerization initiator containing a salt composed of a hexafluorophosphate anion and a cation, a thermal cationic polymerization initiator containing a salt composed of a tetrakis(pentafluorophenyl)borate anion and a cation, and the like, and among these, from the viewpoint of excellent low-temperature curability, a thermal cationic polymerization initiator containing a salt composed of a tetrakis (pentafluorophenyl)borate anion and a cation is preferable. Examples of the cation include a quaternary ammonium cation, a sulfonium ion in which at least one of three groups bonded to a sulfur atom is an alkyl group having 1 to 8 carbon atoms, and the like. Preferred examples of the thermal cationic polymerization initiator containing a salt composed of a tetrakis(pentafluorophenyl)borate anion and a cation include a thermal cationic polymerization initiator containing a salt composed of tetrakis(pentafluorophenyl)borate anion and a quaternary ammonium cation, and the like, from the viewpoint of improving low-temperature curability and permeability. These may be used singly or in combination of two or more kinds thereof.

Examples of commercially available products of the thermal cationic polymerization initiator include SI-60L, SI-80L, SI-100L (manufactured by SANSHIN CHEMICAL INDUSTRY CO., LTD.), SI-110L, SI-180L, SI-B2A, and SI-B3A (manufactured by SANSHIN CHEMICAL INDUSTRY CO., LTD.), CXC-1821 (manufactured by King Industries, Inc.), and the like.

Examples of the photocationic polymerization initiator include an aromatic sulfonium-based photocationic polymerization initiator and an aromatic iodonium-based photocationic polymerization initiator. These may be used singly or in combination of two or more kinds thereof.

Specific examples of the aromatic sulfonium-based photocationic polymerization initiator include triphenylsulfonium hexafluorophosphate, triphenylsulfonium hexafluoroantimonate, triphenylsulfonium tetrakis (pentafluorophenyl)borate, 4,4′-bis[diphenylsulfonio]diphenylsulfide-bishexafluorophosphate, 4,4′-bis[di(-hydroxyethoxy)phenylsulfonio]diphenylsulfide-bishexafluoroantimonate, 4,4′-bis[di(R-hydroxyethoxy)phenylsulfonio]diphenylsulfide-bishexafluorophosphate, 7-[di(p-tolyl)sulfonio]-2-isopropylthioxanthone hexafluoroantimonate, 7-[di(p-tolyl)sulfonio]-2-isopropylthioxanthone tetrakis (pentafluorophenyl)borate, 4-phenylcarbonyl-4′-diphenylsulfonio-diphenylsulfide-hexafluorophosphate, 4-(p-ter-butylphenylcarbonyl)-4′-diphenylsulfonio-diphenylsulfide-hexafluoroantimonate, 4-(p-ter-butylphenylcarbonyl)-4′-di(p-tolyl)sulfonio-diphenylsulfide-tetrakis(pentafluorophenyl)borate, and the like. The aromatic sulfonium-based photocationic polymerization initiator is not limited thereto. These aromatic sulfonium-based photocationic polymerization initiators may be used singly or as a mixture. Examples of the aromatic iodonium-based photocationic polymerization initiator include diphenyliodonium tetrakis (pentafluorophenyl)borate, diphenyliodonium hexafluorophosphate, diphenyliodonium hexafluoroantimonate, di(4-nonylphenyl)iodonium hexafluorophosphate, 4-methylphenyl-4-(1-methylethyl)phenyliodonium tetrakis(pentafluorophenyl)borate, and the like. These may be used singly or in combination of two or more kinds thereof.

Examples of commercially available products of the photocationic polymerization initiator include SP-150, SP-170, and SP-172 (manufactured by ADEKA Corporation), CPI-100P, CPI-101A, CPI-110B, CPI-200K, and CPI-210S (manufactured by San-Apro Ltd.), T1608, T1609, T2041, and T2042 (manufactured by Tokyo Chemical Industry Co., Ltd.), UVI-6990 and UVI-6974 (manufactured by Union Carbide Corporation), DTS-200 (manufactured by Midori Kagaku Co., Ltd.), IRGACURE 250 (manufactured by BASF), PI-2074 (manufactured by Rhodia), B2380, B2381, D2238, D2248, D2253, and 10591 (manufactured by Tokyo Chemical Industry Co., Ltd.), WPI-113, WPI-116, WPI-169, WPI-170, and WPI-124 (manufactured by Wako Pure Chemical Industries, Ltd.), and the like.

Examples of the photobase generator include diazabicycloundecene-based tetraphenylborate salts, tetrabutylammonium butyltriphenylborate, di-tert-butylmethylphosphonium tetraphenylborate, N,N-dimethylanilinium tetrakis (pentafluorophenyl)borate, 4-isopropyl-4′-methyldiphenyliodonium tetrakis (pentafluorophenyl)borate, and the like.

Examples of commercially available products of the photobase generator include U-CAT5002 (manufactured by San-Apro Ltd.), P3B, BP3B, N3B, and MN3B (manufactured by Showa Denko K.K.), and the like.

When the component (C) is a thermal curing agent, the softening point or melting point is preferably in a range of 70 to 150° C., further preferably 80 to 140° C., and most preferably 90 to 130° C., from the viewpoint of low-temperature curability and storage stability. When the component (C) is an amine adduct compound, the amine value is preferably 70 to 200, more preferably 90 to 150, and most preferably 100 to 130, from the viewpoint of low-temperature curability.

The 50% average particle size of the component (C) is preferably 0.1 to 50 μm, further preferably 1 to 30 μm, and particularly preferably 2 to 20 μm, from the viewpoint of permeability, low-temperature curability, and storage stability. When the 50% average particle size is 0.1 μm or more, the component (C) is easily dispersed in the component (A), has no problem such as sedimentation, and is excellent in stability as the curable resin composition. When the 50% average particle size is 50 μm or less, a more stable cured product can be obtained since capillary action hardly occurs without affecting permeability. Examples of a method for confirming the 50% average particle size include image analysis using a particle size/shape distribution measuring instrument of a laser diffraction scattering type or a micro-sorting control type, an optical microscope, an electron microscope, and the like. In the present invention, a laser diffraction scattering type is used.

The component (C) is contained in an amount of preferably 0.1 to 50 parts by mass, more preferably 1 to 40 parts by mass, and most preferably 5 to 30 parts by mass, with respect to 100 parts by mass of the component (A). When the content is 0.1 to 50 parts by mass, stable curability can be maintained without deteriorating storage stability.

The component (D) used in the present invention is a reactive diluent. The reactive diluent described in the present invention refers to a compound that can reduce the viscosity of the component (A) and can react with the component (C). By adding the component (D), permeability can be improved without deteriorating curability. From the viewpoint of permeability, a compound having one or two reactive functional groups is preferable, and a compound having one reactive functional group is more preferable. From the viewpoint of compatibility with the component (A) and reactivity with the component (C), a compound having a glycidyl group as a reactive functional group is preferable. In particular, from the viewpoint that the adhesive force in physical properties of a cured product and durability against high temperature and high humidity are not lowered, a glycidyl ether having a linear or branched chain and a glycidyl ether having an aromatic ring are preferable, a glycidyl ether having an aromatic ring is more preferable, a phenyl glycidyl ether having an alkyl group having 1 to 10 carbon atoms is most preferable. An alkyl group having 1 to 10 carbon atoms is directly bonded to a phenyl group. Specific examples of the component (D) include methyl phenyl glycidyl ether, ethyl phenyl glycidyl ether, propyl phenyl glycidyl ether, butyl phenyl glycidyl ether, pentyl phenyl glycidyl ether, hexyl phenyl glycidyl ether, heptyl phenyl glycidyl ether, octyl phenyl glycidyl ether, nonyl phenyl glycidyl ether, decyl phenyl glycidyl ether, and the like, and from the viewpoint of compatibility with other components, those having an alkyl group having 1 to 6 carbon atoms are preferable, 4-tert-butyl phenyl glycidyl ether and 4-sec-butyl phenyl glycidyl ether are more preferable, and 4-tert-butyl phenyl glycidyl ether is most preferable. These may be used singly or in combination of two or more kinds thereof.

Examples of commercially available products of the component (D) include ED-502, ED-502S, ED-509E, ED-509S, ED-529, ED-503, ED-503G, ED-506, and ED-523T (manufactured by ADEKA Corporation), Denacol EX-810, EX-811, EX-850, EX-851, EX-821, EX-830, EX-832, EX-841, EX-861, EX-920, EX-931, EX-141, EX-145, EX-146, EX-147, EX-192, EX-201, EX-211, and EX-212 (manufactured by Nagase ChemteX Corporation), and the like.

The viscosity of the component (D) at 25° C. is preferably 0.0001 to 0.5 Pa·s, more preferably 0.001 to 0.2 Pa·s, and most preferably 0.01 to 0.1 Pa·s, from the viewpoint of permeability.

The epoxy equivalent of the component (D) is preferably 10 to 1000 g/eq, more preferably 50 to 500 g/eq, and most preferably 100 to 400 g/eq, from the viewpoint of low-temperature curability.

The component (D) is contained in an amount of preferably 1 to 100 parts by mass, further preferably 5 to 80 parts by mass, and most preferably 10 to 70 parts by mass, with respect to 100 parts by mass of the component (A). When the content is 1 part by mass or more, permeability can be improved, and when the content is 100 parts by mass or less, there is no concern of affecting the physical properties of a cured product.

The component (E) used in the present invention is a thiol curing agent. The component (E) is not particularly limited as long as it has one or more SH groups, and is preferably a compound having two or more SH groups from the viewpoint of curability.

Specific examples of the component (E) include trimethylolpropane tris(3-mercaptopropionate), tris-[(3-mercaptopropionyloxy)-ethyl]-isocyanurate, pentaerythritol tetrakis (3-mercaptopropionate), tetraethylene glycol bis(3-mercaptopropionate), dipentaerythritol hexakis(3-mercaptopropionate)pentaerythritol tetrakis(3-mercaptobutyrate) 1,4-bis(3-mercaptobutyryloxy)butane, 1,3,5-tris(3-mercaptobutyryloxyethyl)-1,3,5-triazine-2,4,6(1H,3H,5H)-trione, trimethylolpropane tris(3-mercaptobutyrate), trimethylolethane tris(3-mercaptobutyrate), trimethylolpropane tris(3-mercaptobutyrate), trimethylolethane tris(3-mercaptobutyrate), 3-methoxybutyl-3-mercaptopropionate, 2-ethylhexyl-3-mercaptopropionate, tridecyl 3-mercaptopropionate, trimethylolpropane tristhiopropionate, pentaerythol tetrakisthiopropionate, methyl thioglycolate, 2-ethylhexyl thioglycolate, ethylene glycol bisthioglycolate, 1,4-butanediol bisthioglycolate, trimethylolpropane tristhioglycolate, pentaerythol tetrakisthioglycolate, di(2-mercaptoethyl)ether, 1-butanthiol, 1-hexanthiol, cyclohexylmercaptan, 1,4-butanedithiol, 3-mercapto-2-butanol, γ-mercaptopropyltrimethoxysilane, benzenethiol, benzylmercaptan, 1,3,5-trimercaptomethylbenzene, 1,3,5-trimercaptomethyl-2,4,6-trimethylbenzene, a terminal thiol group-containing polyether, a terminal thiol group-containing polythioether, a thiol compound obtained by reaction of an epoxy compound with hydrogen sulfide, a thiol compound having a terminal thiol group obtained by reaction of a polythiol compound with an epoxy compound, and the like. Since humidity is bad for many electronic components, those having low hydrolyzability under high temperature and high humidity are preferable, and those having no ester bond are more preferable. From the viewpoint of wettability and permeability to a metal member, a thiol having a disulfide bond or a terminal thiol group-containing polyether is preferable. These may be used singly or in combination of two or more kinds thereof.

The weight average molecular weight of the component (E) is preferably 100 to 3000 g/mol, further preferably 200 to 2000 g/mol, and most preferably 300 to 1500 g/mol, from the viewpoint of low-temperature curability. The weight average molecular weight of the present invention is a value measured by Gel Permeation Chromatography (GPC) using polyethylene glycol as a standard substance. The thiol equivalent of the component (E) is preferably 0.5 to 1000 g/eq, preferably 1 to 700 g/eq, and most preferably 10 to 500 g/eq, from the viewpoint of low-temperature curability.

Examples of commercially available products of the component (E) include, but are not limited to, BMPA, MPA-80, EHMP, NOMP, MBMP, STMP, TMMP, TEMPIC, PEMP, EGMP-4, and DPMP (manufactured by SC Organic Chemical Co., Ltd.), Karenz MTPE1, BD1, NR1, and TPMB (manufactured by Showa Denko K.K.), THIOKOL LP-33, LP-3, LP-980, LP-23, LP-56, LP-55, LP-12, LP-32, LP-2, and LP-31 (manufactured by TORAY FINE CHEMICALS CO., LTD.), TS-G and C3TS-G (manufactured by SHIKOKU CHEMICALS CORPORATION), and the like.

The component (E) is contained in an amount of preferably to 300 parts by mass, more preferably 20 to 200 parts by mass, and most preferably 50 to 150 parts by mass, with respect to 100 parts by mass of the component (A). When the content is parts by mass or more, permeability and curability can be improved, and when the content is 300 parts by mass or less, there is no concern that the physical properties of a cured product such as adhesive strength are significantly deteriorated.

The equivalent ratio (A)/(E) of functional groups of the component (A) and the component (E) is preferably 0.05 to 2.0 and more preferably 0.1 to 0.8. When the equivalent ratio is 0.05 to 2.0, curability is not deteriorated.

Additives such as an inorganic filler other than the component (B), an organic filler, a pigment, a dye, a silane coupling agent, a leveling agent, a rheology control agent, a storage stabilizer may be further contained in an appropriate amount as long as the characteristics of the present invention are not impaired.

Examples of the inorganic filler other than the component (B) include, but are not limited to, alumina powder, calcium carbonate powder, talc powder, silica powder, fumed silica powder, silver powder, nickel powder, palladium powder, carbon powder, tungsten powder, plating powder, and the like. A preferred range of the blending amount of the inorganic filler is preferably 1 to 50 parts by mass and more preferably 5 to 30 parts by mass, with respect to 100 parts by mass of the component (A). From the viewpoint of permeability, those having an average particle size of 0.05 to 10 μm are preferable.

The organic filler may be an organic powder composed of rubber, elastomer, plastic, polymer (or copolymer), or the like. An organic filler having a multilayer structure such as a core-shell type may be used. The average particle size of the organic filler is preferably in a range of 0.05 to 10 μm. From the viewpoint of improving the characteristics in a durability test, it is preferable to contain a filler composed of a polymer or copolymer of an acrylic acid ester and/or a (meth)acrylic acid ester, or a filler composed of a polymer or copolymer of a styrene compound. A preferred blending amount of the organic filler is preferably 1 to 50 parts by mass and more preferably 5 to 30 parts by mass, with respect to 100 parts by mass of (A).

Examples of the silane coupling agent include glycidyl group-containing silane coupling agents such as 3-acryloxypropyltrimethoxysilane, 3-glycidoxypropylmethyldimethoxysilane, 3-glycidoxypropylmethyldiethoxysilane, 3-glycidoxypropylmethyldipropyloxysilane, 3-glycidoxypropyldimethylmonomethoxysilane, 3-glycidoxypropyldimethylmonoethoxysilane, 3-glycidoxypropyldimethylmonopropyloxysilane, 2-(3,4-epoxycyclohexyl)ethyltrimethoxysilane, 3-glycidoxypropyltriethoxysilane, 3-glycidoxypropyltrimethoxysilane, and 3-glycidoxypropylmethyldiethoxysilane; vinyl group-containing silane coupling agents such as vinyltris(β-methoxyethoxy)silane, vinyltriethoxysilane, and vinyltrimethoxysilane; (meth)acrylic group-containing silane coupling agents such as 3-methacryloxypropylmethyldimethoxysilane, 3-methacryloxypropylmethyldiethoxysilane, 3-methacryloxypropyldimethylmonomethoxysilane, 3-methacryloxypropyldimethylmonoethoxysilane, 3-acryloxypropylmethyldipropyloxysilane, 3-acryloxypropylmethyldimethoxysilane, 3-acryloxypropylmethyldiethoxysilane, 3-acryloxypropylmethyldipropyloxysilane, 3-acryloxypropyldimethylmonopropyloxysilane, 3-acryloxypropyldimethylmonomethoxysilane, 3-acryloxypropyldimethylmonoethoxysilane, 3-acryloxypropyldimethylmonopropyloxysilane, and γ-methacryloxypropyltrimethoxysilane; amino group-containing silane coupling agents such as N-β-(aminoethyl)-γ-aminopropyltrimethoxysilane, γ-aminopropyltriethoxysilane, and N-phenyl-γ-aminopropyltrimethoxysilane; γ-mercaptopropyltrimethoxysilane, γ-chloropropyltrimethoxysilane, and the like. Among them, from the viewpoint of excellent adhesive force, a glycidyl group-containing silane coupling agent is more preferable. These may be used singly or in combination of two or more kinds thereof. A preferred blending amount of the silane coupling agent is 0.1 to 20 parts by mass with respect to 100 parts by mass of the component (A).

As the storage stabilizer, boric acid ester, phosphoric acid, alkyl phosphoric acid ester, or p-toluenesulfonic acid can be used. Examples of the boric acid ester include, but are not limited to, tributyl borate, trimethoxyboroxine, ethyl borate, and the like. As the alkyl phosphoric acid ester, trimethyl phosphate, tributyl phosphate, and the like can be used, but the alkyl phosphoric acid ester is not limited thereto. The storage stabilizer may be used singly or as a mixture of plural kinds thereof. In consideration of the influence on cure shrinkage, one or more selected from the group consisting of phosphoric acid, alkyl phosphoric acid ester, boric acid ester, trimethoxyboroxine, and methyl p-toluenesulfonate are preferable, and phosphoric acid and boric acid ester are most preferable. From the viewpoint of maintaining curability and storage stability, a preferred blending amount of the storage stabilizer is 0.1 to 10 parts by mass with respect to 100 parts by mass of the component (A).

<Coating Method>

As a method of applying the curable resin composition of the present invention to an adherend, a known sealing agent or adhesive method is used. For example, methods such as dispensing using an automatic coater, spraying, inkjet, screen printing, gravure printing, dipping, and spin coating can be used. The viscosity (25° C.) of the curable resin composition of the present invention is preferably 10 Pa·s or less, more preferably 7 Pa·s or less, and most preferably 1 Pa·s or less, from the viewpoint of coatability and permeability.

<Material for Adherend>

The curable resin composition of the present invention can be used for various members such as metals and plastic. Examples of the metals include iron, aluminum, stainless steel, gold, silver, copper, nickel, and the like, and examples of the plastic include polypropylene, polyethylene, polyurethane, ABS, a phenolic resin, CFRP (carbon fiber reinforced plastic), GFRP (glass fiber reinforced plastic), 6,6-nylon, PPS, PBT, and the like. In particular, since the curable resin composition of the present invention is excellent in wettability to a metal surface, the curable resin composition can be suitably used for a member containing a metal, and particularly has excellent wettability to nickel.

<Curing Method and Cured Product>

The curable resin composition of the present invention can be cured by heating or irradiation with an active energy ray such as an ultraviolet ray depending on the selection of the component (C) to obtain a cured product. In the case of using a heat-curable curing agent, the curing temperature is preferably 50 to 150° C., more preferably 60 to 120° C., and most preferably 70 to 100° C. The curing time is not particularly limited, and is preferably 1 minute to 3 hours and further preferably 2 minutes to 2 hours in the case of a temperature of 50 to 150° C. In the case of using an active energy ray-curable curing agent, the integrated light amount is preferably 0.1 to 50 kJ/m² and further preferably 1 to 30 kJ/m².

<Use Application>

The curable resin composition of the present invention can be used for various use applications. Specific examples of use applications for which the curable resin composition can be used include adhesion, sealing, cast molding, coating, and the like of an automobile switch part, a head lamp, an engine internal part, an electric part, a driving engine, a brake oil tank, body panels such as a front hood, a fender, and a door, a window, and the like; adhesion, sealing, cast molding, coating, and the like of a flat panel display (a liquid crystal display, an organic EL display, a light-emitting diode display device, or a field emission display), video disc, CD, DVD, MD, a pickup lens, hard disk in the field of electronic materials; adhesion, sealing, coating, and the like of a lithium battery, a lithium ion battery, a manganese battery, an alkaline battery, a fuel cell, a silicon-based solar cell, dye-sensitized battery, an organic solar cell, and the like in the field of batteries; adhesion, sealing, coating, and the like of an optical switch peripheral element, an optical fiber material of optical connector periphery, an optical passive component, an optical circuit component, and an opto-electronic integrated circuit peripheral element in the field of optical components; adhesion, sealing, coating, and the like of a camera module, a lens material, a finder prism, a target prism, a finder cover, an optical receiving sensor part, a shooting lens, a lens of a projection television, and the like in the field of optical apparatuses; and adhesion, lining materials, sealing, coating materials, and the like of gas pipes, water pipes, and the like in the field of infrastructure. Among these, since the curable resin composition of the present invention has low-temperature curability and is excellent in permeability into a narrow portion, the curable resin composition is suitably used for small components constituting an electronic device, and is particularly suitably used for permeation adhesion to a small electronic component having a clearance of 500 μm or less.

### EXAMPLES

The present invention will be described in more detail with reference to Examples, but the present invention is not limited to only these Examples.

### Examples 1 to 3, Comparative Examples 1 to 6, and Reference Examples 1 to 3

The following components were prepared in order to prepare a curable resin composition. As for components (B) and (B′), the silica particles of the core are the same, and those different only in the surface treatment are used.
(A): Bisphenol A type-F type mixed epoxy resin, trade name: EPICLON EXA-835LV (manufactured by DIC Corporation), epoxy equivalent: 165 g/eq, viscosity (25° C.): 2000 mPa·s
(B): Phenylaminosilane (N-phenyl-γ-aminopropyltrimethoxysilane)-treated spherical silica, trade name: SXJ2500-SXJ (manufactured by ADMATECHS COMPANY LIMITED), average particle size: 0.5 μm, specific surface area: 6.0 m²/g
(B′-1): Untreated spherical silica, trade name: SC2500-SQ, average particle size: 0.5 μm specific surface area: 6.0 m²/g
(B′-2): Epoxysilane-treated spherical silica (manufactured by ADMATECHS COMPANY LIMITED), average particle size: 0.5 μm, specific surface area: 6.0 m²/g
(B′-3): Phenylsilane-treated spherical silica (manufactured by ADMATECHS COMPANY LIMITED), average particle size: 0.5 μm, specific surface area: 6.0 m²/g
(B′-4): Methacrylsilane-treated spherical silica (manufactured by ADMATECHS COMPANY LIMITED), average particle size: 0.5 μm, specific surface area: 6.0 m²/g
(B′-5): Vinylsilane-treated spherical silica (manufactured by ADMATECHS COMPANY LIMITED), average particle size: 0.5 μm, specific surface area: 6.0 m²/g
(B′-6): Dimethylsilane-treated spherical silica (manufactured by ADMATECHS COMPANY LIMITED), average particle size: 0.5 μm, specific surface area: 6.0 m²/g
(C): Latent curing agent (modified aliphatic polyamine adduct) trade name: Fujicure FXR-1081 (manufactured by T&K TOKA CO., LTD.), softening point: 125° C., amine value: 115, average particle size: 6 μm
(D): Reactive diluent (p-tert-butylphenyl monoglycidyl ether), trade name: ADEKA GLYCIROL ED-509S (manufactured by ADEKA Corporation), viscosity (25° C.): 20 mPa s, epoxy equivalent: 200 to 230 g/eq
(E): Thiol curing agent (disulfide bond-containing terminal thiol polyether), trade name: LP-3 (manufactured by TORAY FINE CHEMICALS CO., LTD.), viscosity (25° C.): 1.8 Pa·s, weight average molecular weight: 1000 g/mol, thiol group content: 2.0 mol %

The component (A) and the component (B) were weighed in a stirring container and stirred with a mixer for 30 minutes. The component (C) was further added and the mixture was stirred for 10 minutes. In the case of adding the component (D) and the component (E), these components were charged simultaneously with the component (A) and the component (B). The detailed preparation amounts are in accordance with Tables 1 and 2, and all numerical values are expressed in parts by mass. All tests were performed at 25° C.

[Low-Temperature Curability]

To a nickel plate having a size of 25 mm in width×100 mm in length×1.6 mm in thickness, 1 g of each curable resin composition was added dropwise and cured at 80° C. for 30 minutes using a hot air drying furnace. The cured product was poked with a glass rod to check that there was no adhesion of the uncured curable resin composition to the glass rod. When the curable resin composition was not cured, curing was additionally performed at 80° C. for 30 minutes.

<Acceptance Criteria>
◯: No adhesion to the glass rod was observed at 80° C. for 60 minutes.
⊙: No adhesion to the glass rod was observed at 80° C. for 30 minutes.

[Viscosity]

The viscosity of each curable resin composition was measured at a shear rate of 10 s⁻¹ using a cone-plate viscometer.

<Acceptance Criteria>10 Pa·s or Less

The lower limit value is not particularly limited, and is preferably 0.01 Pa·s or more.

[Permeability]

Two nickel plates having a size of 25 mm in width×100 mm in length×1.6 mm in thickness were shifted by 20 mm in a length direction, superposed with a spacer of 200 μm interposed therebetween such that the nickel plate on the front side faced downward, and fixed with a tape to obtain a test piece. The test piece was tilted so that the angle from the base to the test piece was 100 and then fixed to a jig. Under an environment of 25° C., 1 g of each curable resin composition was added dropwise to the upper part of the gap between the shifted nickel plates, and heated at 50° C. for 10 minutes using a hot air drying furnace. After the heating, the tape on which the test piece was fixed was removed, the superposed test piece was peeled off, and the longest distance in which the curable resin composition flowed in (a distance in which the curable resin composition flowed in from the upper part of the nickel plate on the front side) was measured.

TABLE 1

| | | | Comparative | Comparative | Comparative | Comparative | Comparative | Comparative |
|---|---|---|---|---|---|---|---|---|
| | | Example 1 | Example 1 | Example 2 | Example 3 | Example 4 | Example 5 | Example 6 |
| A | EXA-835LV | 100 | 100 | 100 | 100 | 100 | 100 | 100 |
| B | Phenylaminosilane- | 62.5 | | | | | | |
| | treated | | | | | | | |
| B′-1 | Untreated | | 62.5 | | | | | |
| B′-2 | Epoxysilane- | | | 62.5 | | | | |
| | treated | | | | | | | |
| B′-3 | Phenylsilane- | | | | 62.5 | | | |
| | treated | | | | | | | |
| B′-4 | Methacrylsilane- | | | | | 62.5 | | |
| | treated | | | | | | | |
| B′-5 | Vinylsilane-treated | | | | | | 62.5 | |
| B′-6 | Dimethylsilane- | | | | | | | 62.5 |
| | treated | | | | | | | |
| C | FXR-1081 | 17 | 17 | 17 | 17 | 17 | 17 | 17 |
| D | ED-509S | | | | | | | |
| E | LP-3 | | | | | | | |

| Low-temperature | | ◯ | ◯ | ◯ | ◯ | ◯ | ◯ | ◯ |
|---|---|---|---|---|---|---|---|---|
| curability | | | | | | | | |
| Viscosity | Pa · s | 5.8 | 6.5 | 7.6 | 5.4 | 6.6 | 6.8 | 6.1 |
| Permeability | mm | 30 | 10 | 6 | 16 | 8 | 7 | 8 |

TABLE 2

| | | | | Reference | Reference | Reference |
|---|---|---|---|---|---|---|
| | | Example 2 | Example 3 | Example 1 | Example 2 | Example 3 |
| A | EXA-835LV | 100 | 100 | 100 | 100 | 100 |
| B | Phenylaminosilane- | 50 | 55 | | | |
| | treated | | | | | |
| B′-1 | Untreated | | | | | |
| B′-2 | Epoxysilane-treated | | | | | |
| B′-3 | Phenylsilane-treated | | | | | |
| B′-4 | Methacrylsilane- | | | | | |
| | treated | | | | | |
| B′-5 | Vinylsilane-treated | | | | | |
| B′-6 | Dimethylsilane-treated | | | | | |
| C | FXR-1081 | 3 | 7 | 17 | 3 | 7 |
| D | ED-509S | 10 | 60 | | 10 | 60 |
| E | LP-3 | | 70 | | | 70 |

| Low-temperature curability | | ◯ | ⊙ | ◯ | ◯ | ◯ |
|---|---|---|---|---|---|---|
| Viscosity | Pa · s | 0.51 | 0.42 | 3.4 | 0.26 | 0.21 |
| Permeability | mm | 45 | 55 | 25 | 43 | 52 |

As shown in Tables 1 and 2, it is found that the composition of Example 1 containing silica treated with phenylaminosilane is superior in permeability to the composition containing no silica as in Reference Example 1 and the composition containing untreated silica as in Comparative Example 1. It is found that, as in Comparative Examples 2 to 6, permeability is significantly deteriorated in other surface-treated silica. It is found that the composition of Example 1 is superior in permeability to Reference Example 1 containing no silica in spite of the high viscosity. It is found that Example 2 is the composition containing the component (D), but is more excellent in permeability. It is found that Example 2 has a viscosity higher than that of Reference Example 2 containing the component (D) but not containing the component (B), but exhibits excellent permeability. It is found that when the component (E) is contained, the composition can be cured more quickly from the viewpoint of low-temperature curability. It is found that Example 3 has a viscosity higher than that of Reference Example 3 containing the component (D) and the component (E) but not containing the component (B), but exhibits excellent permeability. As described above, in the invention of the present application, a curable resin composition having low-temperature curability and excellent permeability can be obtained by containing the components (A) to (C), and a curable resin composition having more excellent permeability and low-temperature curability can be obtained by appropriately containing the component (D) and the component (E).

### INDUSTRIAL APPLICABILITY

Since the curable resin composition of the present invention has low-temperature curability and is excellent in permeability, the curable resin composition is useful in various fields as an adhesive, a sealing agent, and a potting agent to be used by filling a clearance of a small component.

The present application is based on Japanese Patent Application No. 2021-032251 filed on Mar. 2, 2021, the disclosure content of which is incorporated herein by reference in its entirety.

1. A curable resin composition comprising components (A) to (C) below and having a viscosity at 25° C. of 10 Pa·s or less:
the component (A): a compound having two or more epoxy groups;
the component (B): silica treated with phenylaminosilane; and
the component (C): a compound curing the component (A).

2. The curable resin composition according to claim 1, wherein the component (A) is a compound having a bisphenol skeleton.

3. The curable resin composition according to claim 1, wherein the component (C) is an amine adduct latent curing agent.

4. The curable resin composition according to claim 1, wherein a softening point or melting point of the component (C) is 150° C. or lower.

5. The curable resin composition according to claim 1, further comprising a reactive diluent as a component (D).

6. The curable resin composition according to claim 5, wherein the reactive diluent is an epoxy compound having an aromatic ring.

7. The curable resin composition according to claim 1, further comprising a thiol curing agent as a component (E).

8. The curable resin composition according to claim 7, wherein the thiol curing agent is a thiol curing agent containing no ester bond.

9. The curable resin composition according to claim 1, being used for an adherend containing nickel.

10. A cured product of the curable resin composition according to claim 1.
